(19) United States
(12) Patent Application Publication
(10) Pub. No.: US 2025/0285851 A1
(43) Pub. Date: Sep. 11, 2025

(54) Mass Spectrometer

(71) Applicant: SHIMADZU CORPORATION, Kyoto-shi (JP)

(72) Inventors: Yohei ARAO, Kyoto-shi (JP); Yuta MIYAZAKI, Kyoto-shi (JP); Hidenori TAKAHASHI, Kyoto-shi (JP)

(21) Appl. No.: 19/067,143

(22) Filed: Feb. 28, 2025

(30) Foreign Application Priority Data
Mar. 6, 2024 (JP) 2024-033518

(51) Int. Cl. H01J 49/00

(52) U.S. Cl. CPC H01J 49/005

(57) ABSTRACT

The mass spectrometer according to the present disclosure is a mass spectrometer that generates a group of product ions from a precursor ion derived from a sample component having a hydrocarbon chain and performs mass spectrometry thereon, and includes a reaction chamber, an electrode, an introduction unit, a mass separation unit, a detection unit, a power supply unit, and a controller. The controller performs mass spectrometry on the sample component while alternating between a first analysis mode in which ions are detected in a first polarity mode and in a multimode, and a second analysis mode in which ions are detected in a second polarity mode and in a single mode.

### CROSS REFERENCE TO RELATED APPLICATIONS

This non-provisional application is based on Japanese Patent Application No. 2024-033518 filed on Mar. 6, 2024 with the Japan Patent Office, the entire contents of which are hereby incorporated by reference.

### BACKGROUND OF THE INVENTION

### Field of the Invention

The present disclosure relates to a mass spectrometer that generates a group of product ions from precursor ions derived from a sample component and performs mass spectrometry thereon.

### Description of the Background Art

In order to identify a polymer compound or analyze the structure thereof, a mass spectrometry method is widely used in which ions (precursor ions) derived from a sample component are dissociated for one or more times to generate a group of fragment ions (a group of product ions), and the group of product ions are separated and detected according to the mass-to-charge ratio of each ion.

As a fragmentation method for generating a group of product ions from precursor ions, there is known a collision induced dissociation (CID) method in which precursor ions are excited to collide with a predetermined gas to induce dissociation.

In addition, WO 2018/186286 and WO 2019/155725 disclose a fragmentation method in which precursor ions derived from a sample component having a hydrocarbon chain are selectively dissociated at the position of an unsaturated bond contained in the hydrocarbon chain by irradiating the precursor ions with radicals having oxidation capacity. Hereinafter, the fragmentation method in which precursor ions are selectively dissociated at the position of an unsaturated bond contained in the hydrocarbon chain by irradiating the precursor ions with radicals is also referred to as OAD (Oxygen Attachment Dissociation) method.

WO 2021/028341 discloses a mass spectrometry method which generates a group of product ions by performing both CID and OAD on precursor ions to obtain more information useful for structural analysis of a compound in a single run of mass spectrometry.

### SUMMARY OF THE INVENTION

One typical polymer compound is a lipid, and it is known that characteristics of a lipid vary depending on the length of a hydrocarbon chain or the position of an unsaturated bond contained in the hydrocarbon chain. Therefore, in the analysis of a lipid, it is effective to generate and detect product ions useful for estimating the length of the hydrocarbon chain and the position of an unsaturated bond contained in the hydrocarbon chain.

One of the lipids is a phospholipid, and the phospholipid has a basic structure in which two kinds of fatty acids and a polar group containing phosphoric acid are bonded to glycerol. WO 2021/028341 discloses a method of estimating the structure of a phospholipid based on a product ion spectrum obtained by generating a group of product ions from a sample component which is a phospholipid according to both the CID method and the OAD method and performing mass spectrometry thereon.

Specifically, WO 2021/028341 discloses a method of estimating the structure of a phospholipid by extracting possible candidate structures for the phospholipid based on an accurate mass of precursor ions and conditions of a basic structure of a phospholipid, simulating a product ion spectrum for each extracted candidate structure, and comparing an actually measured product ion spectrum with the simulation result. According to this estimation method, in order to reduce the processing load required for the estimation by narrowing down candidate structures and improve estimation accuracy, it is necessary to obtain more information useful for structural analysis of a compound. However, in order to obtain more information useful for structural analysis of a compound, it is necessary to perform more analysis, which lengthens analysis time and increases sample consumption.

The present disclosure has been made to solve such a problem, and an object of the present disclosure is to obtain more information in a single run of mass spectrometry.

The mass spectrometer of the present disclosure is a mass spectrometer that generates a group of product ions from a precursor ion derived from a sample component having a hydrocarbon chain and performs mass spectrometry thereon. The mass spectrometer includes: a reaction chamber into which the precursor ion is introduced; an electrode disposed in the reaction chamber; an introduction unit that introduces a collision gas and radicals into the reaction chamber as a substance to trigger fragmentation of the precursor ion; a mass separation unit that separates a group of ions including the group of product ions generated in the reaction chamber according to the mass-to-charge ratio of each ion; a detection unit that detects the group of ions separated by mass in the mass separation unit; a power supply unit that applies a voltage to each of the electrode and the mass separation unit; and a controller. The controller is configured to switch between a multimode in which the power supply unit is controlled to apply a predetermined first voltage to the electrode with the introduced collision gas and radicals present in the reaction chamber, and a single mode in which the power supply unit is controlled to apply a predetermined second voltage to the electrode with the introduced collision gas present in the reaction chamber. The controller is configured to switch between a first polarity mode in which the power supply unit is controlled to apply a third voltage to the mass separation unit so as to separate by mass a group of ions with a first polarity, and a second polarity mode in which the power supply unit is controlled to apply a fourth voltage to the mass separation unit so as to separate by mass a group of ions with a second polarity opposite to the first polarity. The controller is configured to perform mass spectrometry on the sample component while alternating between a first analysis mode in which ions are detected in the first polarity mode and the multimode, and a second analysis mode in which ions are detected in the second polarity mode and the single mode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a schematic configuration of a mass spectrometer according to a first embodiment;

FIG. 2 is a diagram illustrating a schematic configuration of an introduction unit;

FIG. 3 is a diagram schematically illustrating a relationship between a voltage applied to an ion guide and an abundance of a group of product ions;

FIG. 4 is a flowchart illustrating an example analysis flow for analyzing a lipid;

FIG. 5 is an MS/MS spectrum obtained by subjecting [M+HCOO]⁻ (m/z=826.5604) obtained at the first time to CID-MS/MS analysis in a negative ion mode;

FIG. 6 is an MS/MS spectrum obtained by subjecting [M+HCOO]⁻ (m/z=826.5604) obtained at the second time to CID-MS/MS analysis in a negative ion mode;

FIG. 7 is an MS/MS spectrum obtained by subjecting [M+H]⁺ (m/z=782.5695) obtained at the first time to multi-MS/MS analysis in a positive ion mode;

FIG. 8 is an MS/MS spectrum obtained by subjecting [M+H]⁺ (m/z=782.5695) obtained at the second time to multi-MS/MS analysis in a positive ion mode;

FIG. 9 is a diagram illustrating a basic structure of phosphatidylcholine; and

FIG. 10 is a diagram illustrating an estimated structure of phosphatidylcholine (36:4).

### DESCRIPTION OF THE PREFERRED EMBODIMENTS

Hereinafter, embodiments of the present disclosure will be described in detail with reference to the drawings. In the drawings, the same or corresponding portions will be denoted by the same reference numerals, and the description thereof will not be repeated.

### [Overall Configuration of Mass Spectrometer]

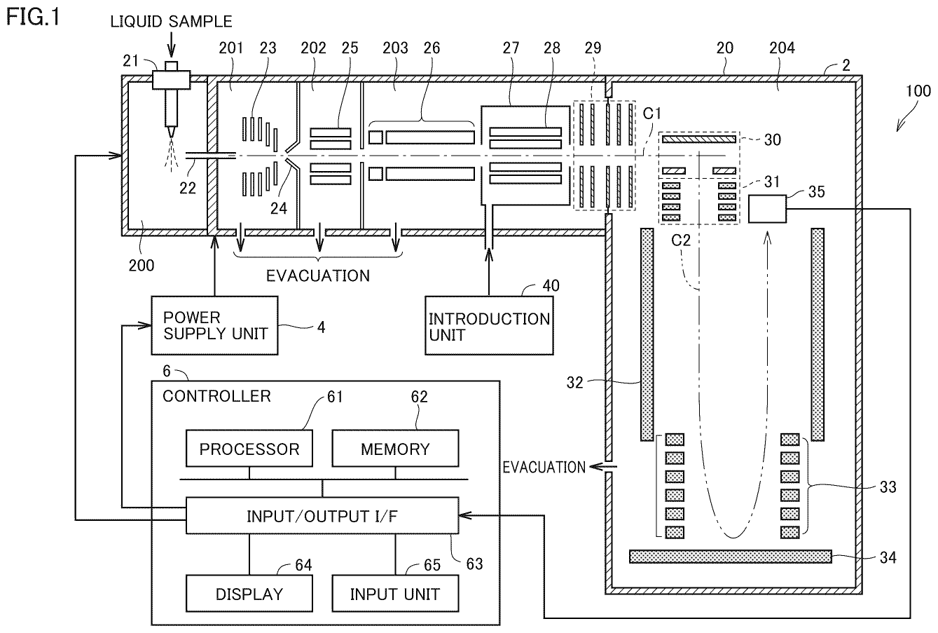

FIG. 1 is a diagram illustrating a schematic configuration of a mass spectrometer according to a first embodiment. The mass spectrometer 100 is a quadrupole (Q)-time of flight (TOF) mass spectrometer. In the following description, the mass spectrometer 100 is described as a Q-TOF mass spectrometer, but it may be any mass spectrometer capable of performing mass spectrometry on a group of ions obtained by cleaving an ion selected from a group of ions obtained by ionizing a sample. For example, the mass spectrometer 100 may be a tandem mass spectrometer such as a tandem quadrupole (Q-Q) mass spectrometer or a tandem time-of-flight (TOF-TOF) mass spectrometer, or may be a hybrid mass spectrometer such as an IT (ion trap)-TOF mass spectrometer, a Q-ICR (ion cyclotron resonance) mass spectrometer or a Q-Fourier transform mass spectrometer.

The mass spectrometer 100 includes a measurement unit 2 that measures each ion by ionizing a sample and separating ions according to the mass-to-charge ratio of each ion, a power supply unit 4 that applies a voltage to each electrode disposed in the measurement unit 2, and a controller 6 that controls the measurement unit 2 and the power supply unit 4.

The measurement unit 2 includes an ionization chamber 200 having an atmosphere of substantially atmospheric pressure and a vacuum chamber 20 which is divided into four sections. The inner space of the vacuum chamber 20 is divided into a first intermediate chamber 201, a second intermediate chamber 202, a first analysis chamber 203, and a second analysis chamber 204, and each chamber is evacuated by a vacuum pump (not shown) so that the degree of vacuum increases in this order.

An electrospray ionization (ESI) source 21 is disposed in the ionization chamber 200 to ionize a compound in a liquid sample by spraying the liquid sample with an electric charge. The method of ionizing a compound is not limited thereto, and may be a method using another ion source such as an atmospheric pressure chemical ion source. An ionization source that ionizes a gas sample or a solid sample instead of a liquid sample may be used.

As an example, a liquid chromatograph is connected to the mass spectrometer 100, and an eluate from the liquid chromatograph is continuously introduced into the ESI source 21. Alternatively, a liquid sample may be continuously introduced into the ESI source 21 by a flow injection analysis method. In addition, the liquid sample may be intermittently introduced into the mass spectrometer 100.

The ionization chamber 200 and the first intermediate chamber 201 communicate with each other through a desolvation pipe 22. Ions derived from the sample component and charged minute droplets generated in the ionization chamber 200 are drawn into the desolvation pipe 22 and sent to the first intermediate chamber 201 mainly by a pressure difference between the ionization chamber 200 and the first intermediate chamber 201. The desolvation tube 22 is, for example, a heating capillary, and when the charged droplets pass through the desolvation tube 22, the solvent in the droplets vaporizes, promoting the ion formation.

A multipole ion guide 23 is disposed in the first intermediate chamber 201. The ions sent to the first intermediate chamber 201 are converged in the vicinity of an ion optical axis C1 by the ion guide 23 and sent to the second intermediate chamber 202 through an opening at the top of a skimmer 24.

A multipole ion guide 25 is disposed in the second intermediate chamber 202. The ions in the second intermediate chamber 202 are sent from the second intermediate chamber 202 to the first analysis chamber 203 by the ion guide 25.

A quadrupole mass filter 26 that selects a specific group of ions from the group of ions derived from the sample component as precursor ions, a reaction chamber 27 into which the precursor ions selected by the quadrupole mass filter 26 are introduced, an ion guide 28 that is an electrode disposed in the reaction chamber 27, and a part of a transfer electrode 29 that transports the ions emitted from the reaction chamber 27 are disposed in the first analysis chamber 203. The quadrupole mass filter 26 corresponds to an “ion selection unit” according to the present disclosure. The ion selection unit for selecting precursor ions is not limited to the quadrupole mass filter 26, and may be, for example, a TOF or IT.

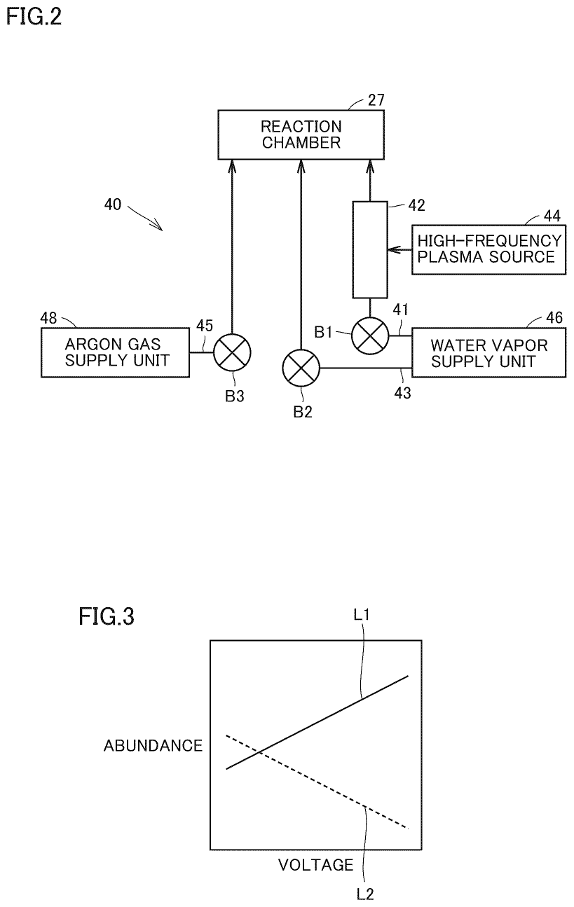

The measurement unit 2 includes an introduction unit 40 that introduces a substance into the reaction chamber 27 to trigger fragmentation of the precursor ions introduced into the reaction chamber 27. The configuration of the introduction unit 40 will be described later with reference to FIG. 2. Water vapor and hydroxy radicals produced from water vapor are continuously or intermittently introduced from the introduction unit 40 into the reaction chamber 27. In addition, an inert gas such as argon gas may be introduced from the introduction unit 40 into the reaction chamber 27.

When the precursor ions introduced into the reaction chamber 27 collide with water vapor, the precursor ions are dissociated by collision induced dissociation (CID) to generate one or more product ions. Hereinafter, one or a plurality of product ions generated by CID are also referred to as a “first group of product ions”. The precursor ions introduced into the reaction chamber 27 reacts with the hydroxy radical and are selectively dissociated at the position of an unsaturated bond contained in the hydrocarbon chain to generate one or more product ions. A fragmentation method in which precursor ions are selectively dissociated at the position of an unsaturated bond contained in a hydrocarbon chain by irradiating the precursor ions with radicals is hereinafter referred to as “OAD (Oxygen Attachment Dissociation)”. One or a plurality of product ions generated by OAD are also referred to as a “second group of product ions”.

The first group of product ions and/or the second group of product ions generated in the reaction chamber 27 are sent to the transfer electrode 29.

The group of ions emitted from the reaction chamber 27 are converged by the transfer electrode 29 and sent to the second analysis chamber 204 as a highly parallel ion stream. A detection unit is disposed in the second analysis chamber 204 to detect the group of ions sent to the second analysis chamber 204 according to the mass-to-charge ratio of each ion. The detection unit includes a mass separation unit that separates a group of ions including the group of product ions generated in the reaction chamber 27 according to the mass-to-charge ratio of each ion, and a detector 35 that detects each ion separated by the mass separation unit.

More specifically, an orthogonal acceleration electrode 30, an acceleration electrode 31, a flight tube 32, a reflectron 33, a back plate 34, a detector 35, and the like are disposed in the second analysis chamber 204. The group of ions, which are sent to the second analysis chamber 204 as a highly parallel ion stream, are emitted by the orthogonal acceleration electrode 30 in a direction substantially perpendicular to the incident direction of the ion stream.

The group of ions are emitted from the orthogonal acceleration electrode 30 in a pulsed manner, i.e., as a single ion packet. The group of ions emitted from the orthogonal acceleration electrode 30 are further accelerated by the acceleration electrode 31 and introduced into a flight space in the flight tube 32. An electric field is formed in the flight space by the flight tube 32, the reflectron 33 and the back plate 34 to cause the ions to turn back and fly along a path indicated by C2 in FIG. 1. As a result, the ions are turned back to fly through the flight tube 32 and reach the detector 35. The detector 35 outputs, to the controller 6, an ion intensity signal corresponding to the amount of incident ions and a time for the ions to reach the detector 35.

The group of ions sent to the second analysis chamber 204 are applied with a constant amount of kinetic energy by the orthogonal acceleration electrode 30 and introduced into the flight space. Since an ion having a smaller mass-to-charge ratio is accelerated at a higher speed by the orthogonal acceleration electrode 30, the arrival time to the detector 35 changes according to the mass-to-charge ratio of the ion, and thereby ions are separated according to the mass-to-charge ratio of each ion. In other words, the mass separation unit that separates ions according to the mass-to-charge ratio of each ion includes at least the orthogonal acceleration electrode 30, the acceleration electrode 31, the flight tube 32, and the back plate 34 which are disposed in the second analysis chamber 204.

The power supply unit 4 applies a predetermined voltage to the orthogonal acceleration electrode 30, the acceleration electrode 31, the flight tube 32, the back plate 34, the ion guides 23, 25 and 28, the transfer electrode 29, and the quadrupole mass filter 26, respectively.

The power supply unit 4 applies a negative voltage or a positive voltage to each electrode including the quadrupole mass filter 26, the orthogonal acceleration electrode 30, the acceleration electrode 31, the flight tube 32, and the back plate 34 in accordance with an instruction from the controller 6. For example, when the mass spectrometry is performed on positive ions of a group of ions derived from the sample component, the power supply unit 4 applies a negative voltage to each electrode. On the other hand, when the mass spectrometry is performed on negative ions of a group of ions derived from the sample component, the power supply unit 4 applies a positive voltage to each electrode.

Hereinafter, the mode in which a negative voltage is applied to each electrode to perform mass spectrometry on positive ions may be referred to as the “positive ion mode”, and the mode in which a positive voltage is applied to each electrode to perform mass spectrometry on negative ions may be referred to as the “negative ion mode”. In other words, the power supply unit 4 switches between the positive ion mode and the negative ion mode in accordance with an instruction from the controller 6.

The controller 6 controls the measurement unit 2 and the power supply unit 4. The controller 6 may be further configured to process a measurement result such as an ion intensity signal sent from the detector 35.

The controller 6 includes a processor 61, a memory 62, an input/output I/F 63, a display 64, and an input unit 65, and is typically a computer.

The processor 61 is typically an arithmetic processing unit such as a central processing unit (CPU) or a micro processing unit (MPU). The processor 61 controls the operation of the controller 6 by reading a program stored in the memory 62 and executing the program. The program includes a program, when executed by a computer, causes the computer to control the measurement unit 2 and the power supply unit 4.

The memory 62 is implemented by a storage device such as a ROM (Read Only Memory), a RAM (Random Access Memory), and an HDD (Hard Disk Drive). The ROM stores programs to be executed by the processor 61. The RAM temporarily stores data to be used during the execution of a program in the processor 61, and functions as a temporary data memory to be used as a work area. The HDD is a nonvolatile storage device. In addition to or instead of the HDD, a semiconductor memory device such as a flash memory may be employed. The programs and/or the data may be stored in an external storage device that may be accessed by the processor 61.

The input/output I/F 63 is an interface for exchanging various data between the processor 61 and an external device connected to the input/output I/F 63. The external device includes a display 64, an input unit 65, the measurement unit 2, and the power supply unit 4. The display 64 displays, for example, an image for receiving an input from the input unit 65 and a processing result such as an analysis result from the processor 61. The input unit 65 typically includes a touch panel, a keyboard, a mouse, and the like. The input unit 65 receives an input operation of a user with respect to the processor 61.

### [Analysis Performed in Mass Spectrometer]

The controller 6 controls the measurement unit 2 and the power supply unit 4 to perform mass spectrometry (MS) analysis and MS/MS analysis. The MS analysis is an analysis method in which ions generated by ionizing a sample in the ionization chamber 200 without cleaving the sample are separated and detected according to the mass-to-charge ratio of each ion. The MS/MS analysis is an analysis method in which specific precursor ions are selected using the quadrupole mass filter 26, a group of product ions are generated in the reaction chamber 27 from the selected precursor ions, and the generated group of product ions are separated and detected according to the mass-to-charge ratio of each ion.

The controller 6 can control the measuring unit 2 and the power supply unit 4 to perform the MS analysis by applying a high frequency voltage for transporting ions to the quadrupole mass filter 26 and the ion guide 28 without introducing a substance into the reaction chamber 27 to trigger fragmentation.

The controller 6 can control the measurement unit 2 and the power supply unit 4 to perform the MS/MS analysis by applying a predetermined voltage obtained by superimposing an RF voltage on a DC voltage to the quadrupole mass filter 26 to trigger fragmentation in the reaction chamber 27.

The controller 6 can perform various MS/MS analyses using different fragmentation methods to generate a group of product ions from precursor ions by changing the substance to be introduced from the introduction unit 40 into the reaction chamber 27 and the voltage to be applied to the ion guide 28. Specifically, the controller 6 can perform CID and OAD. The controller 6 can control the measurement unit 2 and the power supply unit 4 according to a multimode in which CID and OAD are simultaneously performed and a single mode in which one of CID and OAD is performed.

As described above, the controller 6 can perform mass spectrometry by switching between the “positive ion mode” in which the mass spectrometry is performed on positive ions and the “negative ion mode” in which the mass spectrometry is performed on negative ions.

In other words, the mass spectrometer 100 can provide several analysis modes for the MS/MS analysis by changing the polarity of ions to be analyzed and the fragmentation method. Specifically, the mass spectrometer 100 can provide six analysis modes: (1) a positive ion mode and a multimode; (2) a negative ion mode and a multimode; (3) a positive ion mode and a single mode of CID only; (4) a positive ion mode and a single mode of OAD only; (5) a negative ion mode and a single mode of CID only; and (6) a negative ion mode and a single mode of OAD only.

### [Schematic Configuration of Introduction Unit]

FIG. 2 is a diagram illustrating a schematic configuration of an introduction unit. The introduction unit 40 includes a radical generation chamber 42, a high-frequency plasma source 44, a water vapor supply unit 46, and an argon gas supply unit 48. Although not shown in the figure, the introduction unit 40 further includes a vacuum pump that evacuates the radical generation chamber 42.

The radical generation chamber 42 is constituted by, for example, a glass torch, and is disposed with a needle electrode connected to the high-frequency plasma source 44.

The high-frequency plasma source 44 supplies microwaves for generating vacuum discharge in the radical generation chamber 42. When microwaves are supplied from the high-frequency plasma source 44 to the needle electrode, vacuum discharge is generated in the radical generation chamber 42. In other words, the high-frequency plasma source 44 and the needle electrode are an example of a vacuum discharge unit that generates vacuum discharge in the radical generation chamber 42.

The water vapor supply unit 46 supplies water vapor to the radical generation chamber 42 and the reaction chamber 27. The argon gas supply unit 48 supplies argon gas to the reaction chamber 27.

The radical generation chamber 42 communicates with the reaction chamber 27. The radical generation chamber 42 and the water vapor supply unit 46 are connected to each other by a flow path 41. The flow path 41 is provided with a valve B1. A flow path 43 connected to the reaction chamber 27 without passing through the radical generation chamber 42 is connected to the water vapor supply unit 46. The flow path 43 is provided with a valve B2.

When microwaves are supplied to the needle electrode after water vapor has been supplied from the water vapor supply unit 46 to the radical generation chamber 42, vacuum discharge is generated in the radical generation chamber 42, which generates hydroxy radicals from water vapor. The hydroxy radicals generated from water vapor are introduced into the reaction chamber 27 from the radical generation chamber 42. On the other hand, unless microwaves are supplied to the needle electrode, hydroxyl radicals are not generated and are not introduced into the reaction chamber 27. Therefore, the controller 6 can start or stop the introduction of hydroxy radicals into the reaction chamber 27 by controlling the high-frequency plasma source 44.

The flow path 43 connected to the reaction chamber 27 without passing through the radical generation chamber 42 is connected to the water vapor supply unit 46. Therefore, the controller 6 can start or stop the introduction of water vapor into the reaction chamber 27 by controlling the valve B2.

A flow path 45 connected to the reaction chamber 27 is connected to the argon gas supply unit 48. The flow path 45 is provided with a valve B3. The controller 6 can determine start or stop the introduction of argon gas into the reaction chamber 27 by controlling the valve B3.

Water vapor is one type of collision gases to be used in CID. The hydroxy radical is one type of radicals to be used in OAD.

The controller 6 opens the valves B1 and B2 and supplies microwaves from the high-frequency plasma source 44 to the needle electrode to introduce hydroxy radicals and water vapor into the reaction chamber 27. On the other hand, the controller 6 opens the valves B1 and B2 but stops the supply of microwaves from the high-frequency plasma source 44 to the needle electrode to introduce water vapor into the reaction chamber 27 without introducing hydroxy radicals.

As described above, by selecting water vapor as the collision gas and hydroxy radicals produced from water vapor as the radicals, the substance to be introduced into the reaction chamber 27 can be easily controlled only by controlling the high frequency plasma source 44. Further, by selecting water vapor as the collision gas and hydroxy radicals produced from water vapor as the radicals, two types of substances can be supplied from a common source, which simplifies the configuration of the device.

In the present embodiment, the introduction unit 40 includes the argon gas supply unit 48, but it may not include the argon gas supply unit 48. In addition, the mass spectrometer 100 may use argon gas as the collision gas.

In addition, in the present embodiment, the introduction unit 40 includes a flow path for supplying water vapor and a flow path for supplying hydroxy radicals separate from each other. Note that the configuration of the introduction unit 40 is not limited to the configuration illustrated in FIG. 2. The introduction unit 40 may any device as long as it can introduce the collision gas and the radicals into the reaction chamber 27 so that both the collision gas and the radicals are present in the reaction chamber 27.

For example, the introduction unit 40 may not include the flow path 43 and the valve B2. In this case, the introduction unit 40 may introduce hydroxy radicals or water vapor into the reaction chamber 27 by starting or stopping the supply of microwaves from the high-frequency plasma source 44 while continuously supplying water vapor into the radical generation chamber 42. For example, the introduction unit 40 can introduce both hydroxy radicals and water vapor into the reaction chamber 27 by alternately introducing hydroxy radicals and water vapor into the reaction chamber 27.

### [Relationship Between Voltage Applied to Ion Guide and Fragmentation]

How each fragmentation proceeds when a voltage applied to the ion guide 28 changes when CID and OAD are performed in the reaction chamber 27 will be described. FIG. 3 is a diagram schematically illustrating a relationship between a voltage applied to an ion guide and an abundance of a group of product ions. A solid line L1 in FIG. 3 indicates the abundance of a first group of product ions generated by CID. A broken line L2 in FIG. 3 indicates the abundance of a second group of product ions generated by OAD.

When a voltage is applied to the ion guide 28, an amount of energy is applied to the precursor ions introduced into the reaction chamber 27. By applying an amount of energy to the precursor ions, the collision energy when the precursor ions collide with the collision gas is increased, and the fragmentation by CID proceeds. Therefore, as illustrated in FIG. 3, when a voltage applied to the ion guide 28 is increased, the abundance of the first group of product ions generated by CID increases.

On the other hand, since CID and OAD compete against each other, when the fragmentation by CID proceeds, the fragmentation by OAD slows down. Therefore, as illustrated in FIG. 3, when the voltage applied to the ion guide 28 is increased, the abundance of the second group of product ions generated by OAD decreases.

For this reason, it has been considered difficult to perform both the fragmentation by CID and the fragmentation by OAD in one reaction chamber 27.

The present inventors have found that the fragmentation by CID and the fragmentation by OAD can be performed in one reaction chamber 27 by adjusting the voltage applied to the ion guide 28.

The voltage is determined by the balance between the peak intensity (detected intensity) of the first group of product ions generated by CID and the peak intensity of the second group of product ions generated by OAD. In general, the fragmentation by OAD is less likely to occur than the fragmentation by CID. Therefore, the voltage is set to a value which is sufficient low to detect the first group of product ions with reference to the peak intensity of the first group of product ions generated by CID.

### [Analysis Flow]

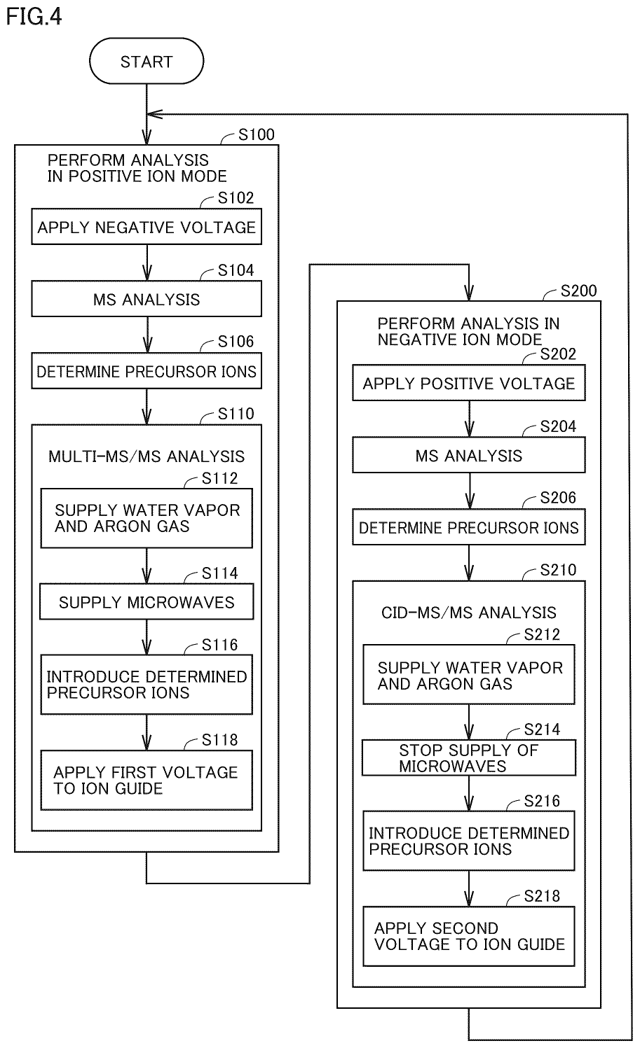

Analysis using the mass spectrometer 100 will be described. The mass spectrometer 100 may perform the MS analysis and the MS/MS analysis in a positive ion mode or may perform the MS analysis and the MS/MS analysis in a negative ion mode. The mass spectrometer 100 analyzes an eluate continuously introduced from a liquid chromatograph by repeating the MS analysis and the MS/MS analysis while alternating between the positive ion mode and the negative ion mode until the set analysis time ends. Hereinafter, as an example, an analysis flow when a lipid is used as a sample to be analyzed will be described. FIG. 4 is a flowchart illustrating an example analysis flow for analyzing a lipid.

In S100, the controller 6 controls the measurement unit 2 and the power supply unit 4 to perform analysis in the positive ion mode. Thus, the MS analysis and the MS/MS analysis are performed in the positive ion mode. S100 includes S102, S104, S106, and S110.

In S200, the controller 6 controls the measurement unit 2 and the power supply unit 4 to perform analysis in the negative ion mode. Thus, the MS analysis and the MS/MS analysis are performed in the negative ion mode. S200 includes S202, S204, S206, and S210.

The controller 6 repeats S100 and S200 until the set analysis time ends. In the present embodiment, the power supply unit 4 is configured to switch the polarity of voltage at high speed, and the controller 6 corrects the deviation of the mass-to-charge ratio caused by the fluctuation of the voltage during the polarity switching. Therefore, in the mass spectrometer 100, the waiting time for switching between the positive ion mode and the negative ion mode is 1 second or less. Any method known to those skilled in the art can be employed as the method of switching the polarity of voltage at high speed and the correction method.

In S102, the controller 6 controls the power supply unit 4 to apply a negative voltage to each electrode (for example, the orthogonal acceleration electrode 30, the acceleration electrode 31, the flight tube 32, and the back plate 34) so as to perform the MS analysis and the MS/MS analysis in the positive ion mode.

In S104, the controller 6 controls the measurement unit 2 and the power supply unit 4 to perform the MS analysis. For example, the controller 6 controls the power supply unit 4 to apply a high frequency voltage for transporting ions to the quadrupole mass filter 26 and the ion guide 28. In addition, the controller 6 controls the measurement unit 2 to stop the supply of water vapor and argon gas from the water vapor supply unit 46 and the argon gas supply unit 48, respectively, so as to prevent the substance that triggers fragmentation from being introduced into the reaction chamber 27.

In S106, the controller 6 determines precursor ions to be subjected to the MS/MS analysis based on the result of the MS analysis obtained in S104. Although the method of determining the precursor ions is not particularly limited, for example, the controller 6 determines ions having a high mass-to-charge ratio at peak intensity as the precursor ions. Note that the method of determining ions having a high mass-to-charge ratio at peak intensity as precursor ions and analyzing the precursor ions is generally referred to as a data dependent acquisition (DDA) method.

In S110, the controller 6 controls the measurement unit 2 and the power supply unit 4 to perform the multi-MS/MS analysis. In the present embodiment, the multi-MS/MS analysis is an MS/MS analysis performed under a multimode in which CID and OAD are simultaneously performed. S110 includes S112, S114, S116, and S118.

In S112, the controller 6 controls the valves B1 to B3 to start the supply of water vapor and argon gas.

In S114, the controller 6 controls the high-frequency plasma source 44 to start the supply of microwaves.

In S116, the controller 6 controls the power supply unit 4 to apply a voltage to the quadrupole mass filter 26 so as to introduce the precursor ions determined in S106 into the reaction chamber 27.

In S118, the controller 6 controls the power supply unit 4 to apply a predetermined first voltage to the ion guide 28.

The controller 6 performs the MS/MS analysis in the positive ion mode and the multimode in S112 to S118. In the positive ion mode, since the mass spectrometry is performed on positive ions, the precursor ions selected in S106 are also positive ions. In other words, in the multi-MS/MS analysis of S110, the positive ions are detected from the first group of product ions and the second group of product ions derived from the positive precursor ions.

In S202, the controller 6 controls the power supply unit 4 to apply a positive voltage to each electrode (for example, the orthogonal acceleration electrode 30, the acceleration electrode 31, the flight tube 32, and the back plate 34) so as to perform the MS analysis and the MS/MS analysis in the negative ion mode.

In S204, the controller 6 controls the measurement unit 2 and the power supply unit 4 to perform the MS analysis. Since the control method is the same as that in S104, the description thereof will not be repeated.

In S206, the controller 6 determines precursor ions to be subjected to the MS/MS analysis based on the result of the MS analysis obtained in S204. Since the method of determining the precursor ions is the same as that in S106, the description thereof will not be repeated.

In S210, the controller 6 controls the measurement unit 2 and the power supply unit 4 to perform the CID-MS/MS analysis. In the present embodiment, the CID-MS/MS analysis is an MS/MS analysis performed under a single mode of CID only. S210 includes S212, S214, S216, and S218.

In S212, the controller 6 controls the valves B1 to B3 to start the supply of water vapor and argon gas.

In S214, the controller 6 controls the high-frequency plasma source 44 to stop the supply of microwaves. Note that S214 may be performed at any time after the multi-MS/MS analysis is performed in S110, and may be performed, and for example, it may be performed between S110 and S202.

In step S216, the controller 6 controls the power supply unit 4 to apply a voltage to the quadrupole mass filter 26 so as to introduce the precursor ions determined in S206 into the reaction chamber 27.

In S218, the controller 6 controls the power supply unit 4 to apply a predetermined second voltage to the ion guide 28. The second voltage may be set in advance based on, for example, a standard substance or the like.

The controller 6 performs the MS/MS analysis in the negative ion mode and the single mode of CID only in S212 to S218. In the negative ion mode, since the mass spectrometry is performed on negative ions, the precursor ions selected in S206 are also negative ions. In other words, in the CID-MS/MS analysis of S210, the negative ions are detected from the first group of product ions derived from the negative precursor ions.

In addition, the analysis is set to start in the positive ion mode in FIG. 4, it may be set to start in the negative ion mode of S200. Alternatively, the CID-MS/MS analysis may be performed in the positive ion mode, and the multi-MS/MS analysis may be performed in the negative ion mode. The processing order of S112 to S118 and S212 to S218 is not limited to this order.

### [Analysis Results]

The mass spectrum obtained by performing the analysis illustrated in FIG. 4 using the mass spectrometer 100 according to the present embodiment and the analysis result of the obtained mass spectrum will be described with reference to FIGS. 5 to 8. The mass spectra illustrated in FIGS. 5 to 8 are MS/MS spectra obtained by separating an extract from mouse liver with a liquid chromatography and analyzing an eluate from the liquid chromatography according to the analysis method illustrated in FIG. 4.

A Nexera (Registered trademark) system (manufactured by Shimadzu Corporation) was used as the liquid chromatograph. The first voltage was set to −35 V, and the second voltage was set to 25 V. Thus, the structure of lipids in the extract from mouse liver could be estimated.

In the MS analysis under the positive ion mode, two peaks of [M+H]⁺ (m/z=782.5695) were obtained at different retention times. The retention times of the two peaks obtained were the first time and the second time, respectively. In the MS analysis in the negative ion mode, two peaks of [M+HCOO]⁻ (m/z=826.5604) were obtained at different retention times. The retention times of the two peaks obtained were the first time and the second time, respectively.

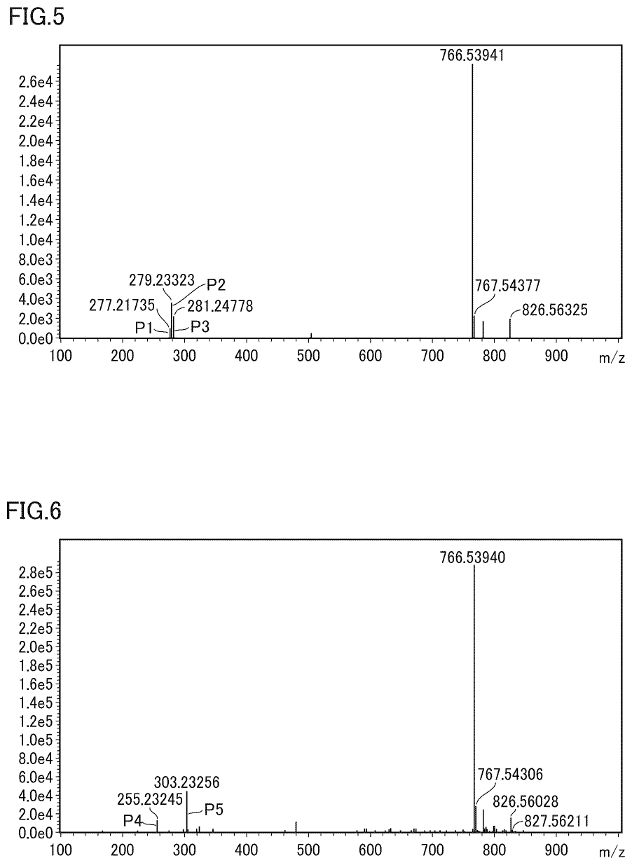

FIG. 5 illustrates an MS/MS spectrum obtained by subjecting [M+HCOO]⁻ (m/z=826.5604) obtained at the first time to the CID-MS/MS analysis in the negative ion mode. FIG. 6 illustrates an MS/MS spectrum obtained by subjecting [M+HCOO]⁻ (m/z=826.5604) obtained at the second time to the CID-MS/MS analysis in the negative ion mode.

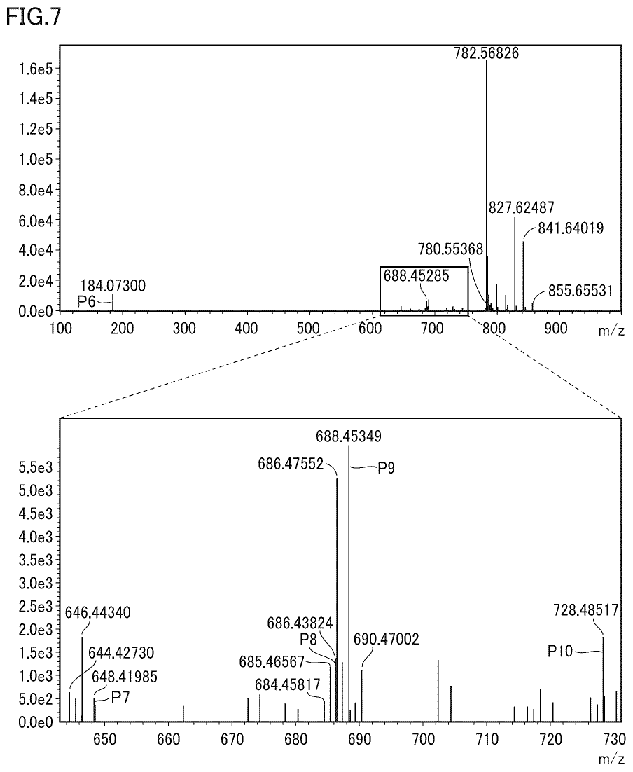

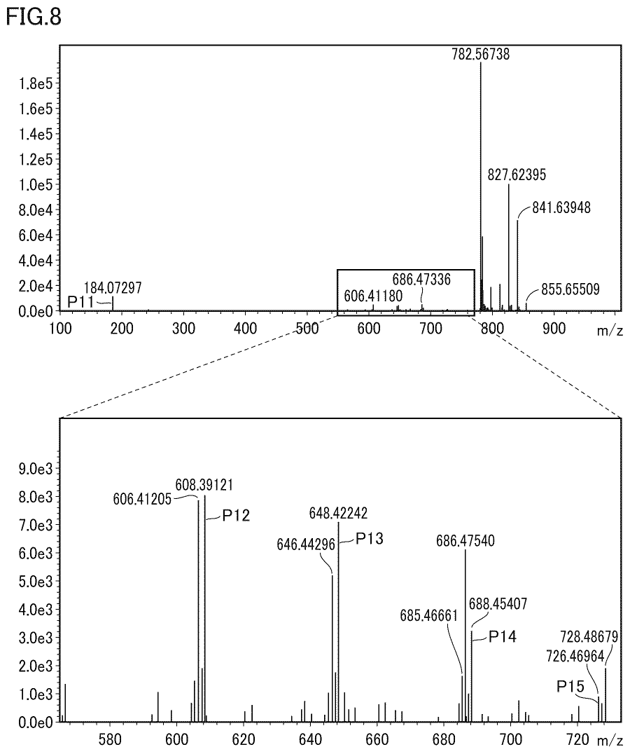

FIG. 7 illustrates an MS/MS spectrum obtained by subjecting [M+H]⁺ (m/z=782.5695) obtained at the first time to the multi-MS/MS analysis in the positive ion mode. FIG. 8 illustrates an MS/MS spectrum obtained by subjecting [M+H]⁺ (m/z=782.5695) obtained at the second time to the multi-MS/MS analysis in the positive ion mode.

By analyzing the MS/MS spectra illustrated in FIGS. 5 and 6, the number of carbons and the number of unsaturated bonds were estimated as the carbon composition of the hydrocarbon chain in the lipid. By analyzing the MS/MS spectra illustrated in FIGS. 7 and 8, the polar groups of the lipid and the positions of double bonds in the hydrocarbon chain were estimated. The estimation method (analysis method) is well known and will not be described in detail in the present disclosure.

As a result of the analysis, it was estimated that peaks P1 to P5 in FIGS. 5 and 6 are peaks of the product ions obtained by CID and correspond to respective side chains. As a result of the analysis, it was estimated peaks P1 to P5 correspond to a hydrocarbon chain (18:3), a hydrocarbon chain (18:2), a hydrocarbon chain (18:1), a hydrocarbon chain (16:0), and a hydrocarbon chain (20:4), respectively. The numbers on the left and right sides in the brackets indicate the number of carbon atoms and the number of double bonds in the respective hydrocarbon chain.

As a result of the analysis, it was estimated that peaks P6 and P11 in FIGS. 7 and 8 are peaks of the polar groups of the lipid. In addition, as a result of the analysis, it was estimated that peaks P7 to P10 and P12 to P15 in FIGS. 7 and 8 are peaks of the product ions obtained by dissociation at the positions of unsaturated bonds (C═C bond) contained in the hydrocarbon chain.

It is known that the peak corresponding to the polar group of a lipid is a peak obtained by CID. The peak of the product ions obtained by dissociation at the positions of unsaturated bonds (C═C bond) is a peak obtained by OAD. In other words, from the mass spectra and the analysis results illustrated in FIGS. 7 and 8, it was confirmed that both the fragmentation by CID and the fragmentation by OAD can be performed in one reaction chamber 27.

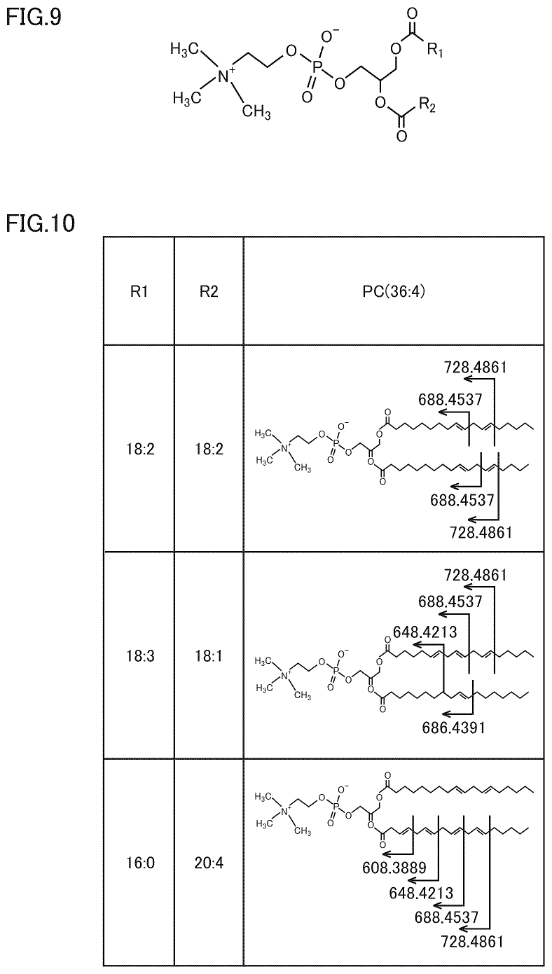

From the peaks corresponding to the first group of product ions illustrated in FIGS. 5 to 8, it was estimated that phosphatidylcholine (PC) (36:4) was contained in the extract extracted from mouse liver. FIG. 9 illustrates a basic structure of phosphatidylcholine. Further, from the peaks obtained by CID, the number of carbon atoms and the number of double bonds of two hydrocarbon chains (R1, R2) in PC (36:4) were estimated. The positions of double bonds in the hydrocarbon chains R1 and R2 were estimated from the peaks corresponding to the second group of product ions illustrated in FIGS. 7 and 8. FIG. 10 illustrates an estimated PC structure (36:4). As illustrated in FIG. 10, it was estimated that the extract extracted from mouse liver contains three kinds of PC (36:4) having different structures.

As described above, it has been found that both the fragmentation by CID and the fragmentation by OAD can be promoted by applying a predetermined voltage to the ion guide 28 after the radicals and the collision gas have been introduced into one reaction chamber 27. Therefore, it is not necessary to perform the two fragmentation methods separately, which makes it possible to shorten analysis time and reduce sample consumption.

By switching the fragmentation method and the polarity, several types of product ions can be detected in a single run of mass spectrometry. Therefore, even for an analysis that requires analysis data from various viewpoints such as the structural analysis of a polymer compound, more information can be obtained in a single run of mass analysis. As a result, it is possible to shorten analysis time and reduce sample consumption while improving the estimation accuracy of the structural analysis.

The combination of the polarity and the fragmentation method according to the present embodiment is an appropriate combination when the sample to be analyzed is a lipid and can be appropriately selected according to the sample to be analyzed.

### Aspects

It will be understood by those skilled in the art that the embodiments described above are specific examples of the following aspects.
(First Aspect) A mass spectrometer according to an embodiment is a mass spectrometer that generates a group of product ions from a precursor ion derived from a sample component having a hydrocarbon chain and performs mass spectrometry thereon. The mass spectrometer includes a reaction chamber into which the precursor ion is introduced; an electrode disposed in the reaction chamber; an introduction unit that introduces a collision gas and radicals into the reaction chamber as a substance to trigger fragmentation of the precursor ion; a mass separation unit that separates a group of ions including the group of product ions generated in the reaction chamber according to the mass-to-charge ratio of each ion; a detection unit that detects the group of ions separated by mass in the mass separation unit; a power supply unit that applies a voltage to each of the electrode and the mass separation unit; and a controller. The controller is configured to switch between a multimode in which the power supply unit is controlled to apply a predetermined first voltage to the electrode with the introduced collision gas and radicals present in the reaction chamber, and a single mode in which the power supply unit is controlled to apply a predetermined second voltage to the electrode with the introduced collision gas present in the reaction chamber. The controller is configured to switch between a first polarity mode in which the power supply unit is controlled to apply a third voltage to the mass separation unit so as to separate by mass a group of ions with a first polarity, and a second polarity mode in which the power supply unit is controlled to apply a fourth voltage to the mass separation unit so as to separate by mass a group of ions with a second polarity opposite to the first polarity. The controller is configured to perform mass spectrometry on the sample component while alternating between a first analysis mode in which ions are detected in the first polarity mode and the multimode, and a second analysis mode in which ions are detected in the second polarity mode and the single mode.

According to the mass spectrometer described in the first aspect, since the mass spectrometry is performed by switching the analysis mode between the first analysis mode and the second analysis mode, the analysis results can be obtained in the first analysis mode and in the second analysis mode in a single run of mass spectrometry, and thus more information can be obtained in a single run of mass spectrometry.
(Second Aspect) In the mass spectrometer according to the first aspect, the first voltage may be set based on a detection intensity of a group of product ions obtained by causing the precursor ion to collide with the collision gas present in the reaction chamber and a group of product ions obtained by causing the precursor ion to react with the radicals present in the reaction chamber.

According to the mass spectrometer described in the second aspect, the voltage can be set to detect both the group of product ions obtained by causing the precursor ions to collide with the collision gas and the group of product ions obtained by causing the precursor ions to react with the radicals.
(Third Aspect) In the mass spectrometer according to the first or second aspect, the group of ions with the first polarity are positive ions, and the group of ions with the second polarity are negative ions. When the sample component to be analyzed is a lipid, the controller is configured to switch between the first analysis mode and the second analysis mode to perform mass spectrometry on the sample component.

According to the mass spectrometer described in the third aspect, the polar groups of the lipid can be estimated based on the analysis result obtained from the mass analysis of the group of product ions obtained by causing the precursor ions to collide with the collision gas in the first analysis mode in the first polarity mode. The number of carbon atoms and the number of unsaturated bonds can be estimated as the carbon composition of the hydrocarbon chain in the lipid based on the analysis result of the group of product ions obtained from the mass analysis the group of product ions obtained by causing the precursor ions to collide with the collision gas in the second analysis mode in the second polarity mode. Further, the positions of double bonds in the hydrocarbon chain can be estimated based on the analysis result obtained from the mass analysis of the group of product ions obtained by causing the precursor ions to react with the radicals in the first analysis mode in the first polarity mode. Therefore, even for an analysis that requires analysis data from various viewpoints such as the structural analysis of a lipid, it is possible to obtain necessary analysis data in a single run of analysis, which makes it possible to shorten analysis time and reduce sample consumption.

Although the embodiments of the present invention have been described, it should be understood that the embodiments disclosed herein are illustrative and non-restrictive in all respects. The scope of the present invention is defined by the scope of the claims and encompasses all modifications equivalent in meaning and scope to the claims.

What is claimed is:

1. A mass spectrometer that generates a group of product ions from a precursor ion derived from a sample component having a hydrocarbon chain and performs mass spectrometry thereon, the mass spectrometer comprising:
a reaction chamber into which the precursor ion is introduced;
an electrode disposed in the reaction chamber;
an introduction unit that introduces a collision gas and radicals into the reaction chamber as a substance to trigger fragmentation of the precursor ion;
a mass separation unit that separates a group of ions including the group of product ions generated in the reaction chamber according to the mass-to-charge ratio of each ion;
a detection unit that detects the group of ions separated by mass in the mass separation unit;
a power supply unit that applies a voltage to each of the electrode and the mass separation unit; and
a controller,
the controller being configured to
switch between a multimode and a single mode, in the multimode the power supply unit being controlled to apply a predetermined first voltage to the electrode with the introduced collision gas and radicals present in the reaction chamber, in the single mode the power supply unit being controlled to apply a predetermined second voltage to the electrode with the collision gas present in the reaction chamber,
switch between a first polarity mode and a second polarity mode, in the first polarity mode the power supply unit being controlled to apply a third voltage to the mass separation unit so as to separate by mass a group of ions with a first polarity, in the second polarity mode the power supply unit being controlled to apply a fourth voltage to the mass separation unit so as to separate by mass a group of ions with a second polarity opposite to the first polarity, and
perform mass spectrometry on the sample component while alternating between a first analysis mode and a second analysis mode, in the first analysis mode ions being detected in the first polarity mode and the multimode, in the second analysis mode ions being detected in the second polarity mode and the single mode.

2. The mass spectrometer according to claim 1, wherein
the first voltage is set based on a detection intensity of a first group of product ions and a second group of product ions, the first group of product ions being obtained by causing the precursor ion to collide with the collision gas present in the reaction chamber, the second group of product ions being obtained by causing the precursor ion to react with the radicals present in the reaction chamber.

3. The mass spectrometer according to claim 1, wherein
the group of ions with the first polarity are positive ions,
the group of ions with the second polarity are negative ions, and
when the sample component to be analyzed is a lipid, the controller is configured to perform mass spectrometry on the sample component while alternating between the first analysis mode and the second analysis mode.

4. The mass spectrometer according to claim 1, wherein
the first voltage is lower than the second voltage.

5. The mass spectrometer according to claim 1, wherein
the alternating between the first analysis mode and the second analysis mode is repeated until a predetermined analysis time ends.

6. The mass spectrometer according to claim 1, wherein
the first voltage is a voltage for detecting both the group of product ions obtained by causing the precursor ion to collide with the collision gas and the group of product ions obtained by causing the precursor ion to react with the radicals.
